(19) United States
(12) Patent Application Publication
(10) Pub. No.: US 2006/0259722 A1
(43) Pub. Date: Nov. 16, 2006

(54) Remote copy system

(76) Inventor: Takashi Watanabe, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/171,220

(22) Filed: Jul. 1, 2005

(30) Foreign Application Priority Data
May 11, 2005 (JP) 2005-138138

(51) Int. Cl. G06F 12/16

(52) U.S. Cl. 711/162

(57) ABSTRACT

An object of the present invention is to provide a remote copy system designed to provide a storage system at a remote site with a function enabling recovery and restoration of a data volume as of a given point in time. The present invention is a remote copy system including a local site having a first storage system connected to an information processing unit, for transmitting and receiving to and from the information processing unit, and a remote site having a second storage system connected to the first storage system, for receiving data from the first storage system. The first storage system includes a first storage area having a first logical volume in which data transmitted from the information processing unit is written, and a first controller for controlling data exchange between the first storage area and the information processing unit. The second storage system includes a second storage area having a second logical volume forming a remote copy pair with the first logical volume, and a plurality of journal volumes storing journal data relating to the first storage area.

### CROSS-REFERENCE TO RELATED APPLICATION

This application relates to and claims priority from Japanese Patent Application No. 2005-138138, filed on May 11, 2005, the entire disclosure of which is incorporated herein by reference.

### BACKGROUND OF THE INVENTION

1. Field of the Invention

The present invention relates to a remote copy system, and specifically relates to data replication between a plurality of storage systems.

2. Description of the Related Art

In present-day society, where computer systems are important to any kind of organization, when a data center that provides a continuous service based on an application program falls into an inoperable state owing to any of various reasons, such as a disaster or accident, it is very important to have the service provided continuously at another data center.

Therefore, a remote copy system is designed to have a first storage system, and a second storage system at a location geographically separate from the first storage system, and a replica of data stored in the first storage system is stored in the second storage system. Examples of the techniques relating to such remote copy systems are: U.S. Pat. No. 6,209,002, which discloses a technique wherein a second storage system has two data replicas of data subject to replication in a first storage system, and a third storage system retains a replica of one of those data replicas; and JP Patent Application Laid-Open (Kokai) Publication No. 2003-122509, which discloses a technique wherein a second storage system has only one data replica of data subject to replication in a first storage system, and a third storage system can obtain a replica of the data replica without requiring a redundant logical volume for performing the remote copy described in U.S. Pat. No. 6,209,002.

### SUMMARY OF THE INVENTION

In a conventional remote copy system, data images of data volumes in a first storage system at a local site are transferred in volume units to data volumes of the same number and capacity in a second storage system at a remote site. Thus, the larger the logical volume capacity of the first storage system becomes, the larger the logical volume capacity of the second storage system will also become.

In order to solve the above-mentioned problem, remote copy techniques using journal volumes have been developing. These remote techniques disclose a journal volume for storing journal data containing update data itself, and management information, such as a time stamp, and a logical address of the location where the update data is stored in a first storage system at a local site (local data center), in addition to a volume for storing ordinary operation data.

Journal data relating to an update transmitted from a server to a volume at the local site in which data subject to remote copy is stored is stored in the journal volume. The content of the journal data stored in the journal volume in the first storage system is transferred to a journal volume in a second storage system and stored therein. The content of the journal data stored in the journal volume in the second storage system is arbitrarily reflected in a volume in the second storage system in case of emergencies, such as a disaster or accident, at the local site.

In remote copy techniques, a recovery point is only recognized as only the point in time when a large-scale failure or the like occurs in a first storage system, or the point in time immediately beforehand. However, it is not sufficient that a recovery point is the point in time when a large-scale failure or the like occurs or a point in time beforehand. For example, where any emergency, such as a failure or erroneous operation, occurs in the middle of file processing in an OS file system that does not obtain log information relating to data updates, an operation that utilizes a second storage system at a remote site so that the point in time when a certain operation is finished or an arbitrary time can be set as the recovery point would be desirable.

In current systems, in order to achieve the aforementioned operation, a recovery operation that restores the content of a back-up acquired before the occurrence of a failure and then applies update logs managed on the application program side to the back-up data may be required. This back-up restore operation and recovery processing, in many cases, requires a great deal of time as well as complicated procedures.

Furthermore, in a system using this remote copy technique, an operation that backs up a volume stored in a second storage system in a data center at a remote site, In another volume in that storage system, utilizing a volume replication function or the like is desirable. In performing the above back-up operation, in order for the second storage system itself to manage the back-up generations, it is necessary to make the second storage system have volumes with the same capacity and number of generations as the back-up.

Therefore, an object of the present invention is to provide a remote copy system designed to provide a storage system at a remote site with a function enabling recovery and restoration of a data volume as of a given point in time.

In order to achieve the above-mentioned object, the present invention is designed to provide a remote copy system that is capable of recovering and restoring a data volume as of a given point in time by providing a plurality of journal volumes in a storage area at a remote site.

In other words, the present invention includes a local site having a first storage system connected to an information processing unit, for transmitting and receiving data to and from the information processing unit; and a remote site having a second storage system connected to the first storage system, for receiving data from the first storage system, wherein the first storage system includes a first storage area having a first logical volume in which data transmitted from the information processing unit is written, and a first controller for controlling data exchange between the first storage area and the information processing unit; and the second storage system includes a second storage area having a second logical volume forming a remote copy pair with the first logical volume, and a plurality of journal volumes storing journal data relating to the first storage area, and a second controller for controlling data exchange between the first storage area and the second storage area.

As described above, according to the present invention, a remote copy system can be provided that is designed to provide a function that enables recovery and restoration of a data volume as of a given point in time.

### BRIEF DESCRIPTION OF THE DRAWINGS

FIG. 1 is a diagram illustrating a first embodiment of the present invention.

FIG. 2 is a diagram illustrating an internal structure of a storage system.

FIG. 3 is a diagram indicating a volume information table.

FIG. 4 is a diagram for explaining a journal.

FIG. 5 illustrates initial copy processing.

FIG. 6 is a diagram indicating pair setting information.

FIG. 7 is a diagram indicating a journal group setting information table.

FIG. 8 is a diagram explaining the flow of access command reception processing.

FIG. 9 is a flowchart explaining the access command reception processing.

FIG. 10 is a diagram explaining the operation of a channel adapter 50 of a storage system 15, that has received a journal read command (journal read command reception processing).

FIG. 11 is a flow chart explaining the journal read command processing.

FIG. 12 is a diagram explaining restore processing.

FIG. 13 is a flowchart explaining recovery processing.

FIG. 14 is a block diagram illustrating another example of a journal volume structure at a remote site.

FIG. 15 is a block diagram illustrating still another example of a journal volume structure.

FIG. 16 is a block diagram illustrating a further example of a journal volume structure.

### DETAILED DESCRIPTION OF THE PREFERRED EMBODIMENTS

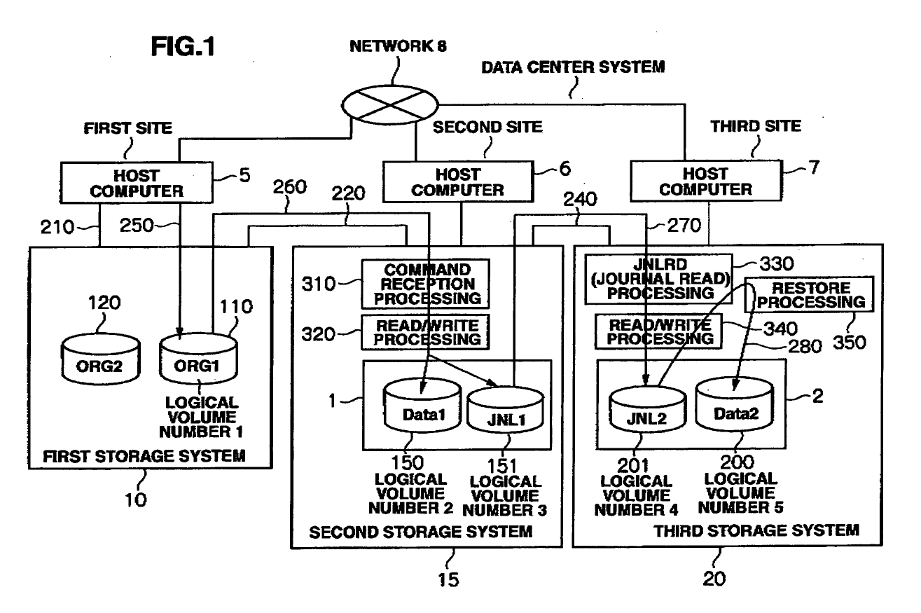

FIG. 1 is a diagram illustrating an entire remote copy system comprising a plurality of storage control systems (hereinafter, referred to as “storage system[s]”) according to an embodiment of the present invention. A first storage system 10 is connected to a host computer 5 via a connection wire 210. A second storage system 15 is connected to the first storage system 10 via a connection wire 220. This second storage system functions as an intermediate site between the first storage system 10 and a third storage system 20. A first site, consisting of the host computer 5 and the first storage system 10, and a second site, consisting of a host computer 6 and the second storage system 15, collectively constitute a local site. Meanwhile, the third storage system 20, which constitutes a remote site, is connected to the storage system 15, which is the second storage system, via a connection wire 240. The connection wires 210, 220 and 240 may be fiber cables, or may also be wide-area network lines, such as that of the Internet. The storage system 10 at the first site includes a logical volume 110 (ORG1) and a logical volume 120 (ORG2), and original data, which is the target of replication, is stored in the logical volume 110 (ORG1). The second storage system 15 includes a logical volume 150 (Data 1) on which synchronous copy of a data image of the logical volume 110 (ORG1) is performed. The storage system 20 at the remote site includes a logical volume 200 (Data 2) in which replicated date is to be stored.

The capacity of a logical volume defined in the storage systems 10, 15 and 20, and the physical location where the logical volume is stored (physical address) can be set using supervising computers (SVP) respectively connected to the storage systems, or the host computers 5, 6 and 7. A logical volume in which data subject to replication is stored is a primary logical volume, and a logical volume in which replicated data is stored is a secondary logical volume. A pair of one primary logical volume and one secondary logical volume constitutes a copy pair. The relationship, status, and the like of the primary logical volume and the secondary logical volume are set as a pair setting information table 500 in a shared memory (SM) 70 in each storage system, as described later.

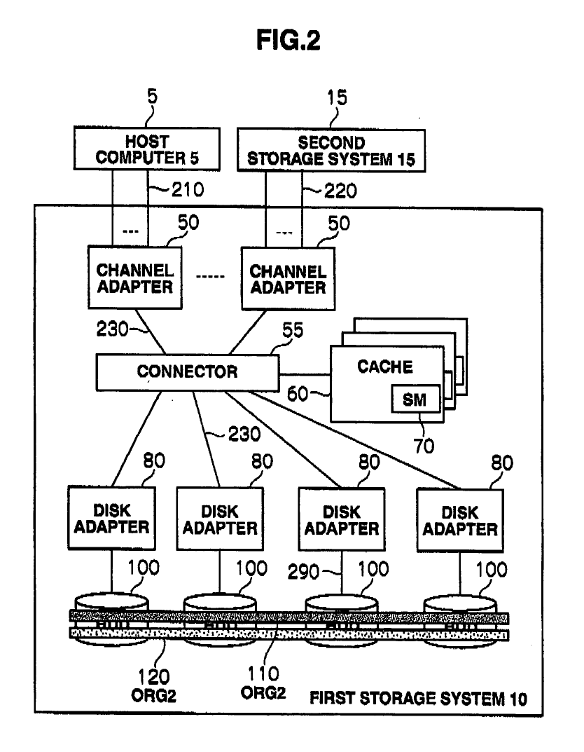

FIG. 2 is a block diagram of hardware of the storage system 10. The storage systems 15 and 20 each have the same structure. The first storage system 10 has a plurality of channel adapters 50 for connecting with the host computer 5, and these channel adapters 50 are connected to the host computer 5 via the connection wire 210, or to the second storage system 15. The channel adapters 50 connected to the host computer 5, which are also connected to a cache memory 60 via a connector 55, analyze commands received from the host system (information processing unit) to control the reading and writing of data from and to the cache memory demanded by the host computer 5. The logical volume 110 (ORG1) and the logical volume 120 (ORG2) are logically set over a plurality of HDDs 100.

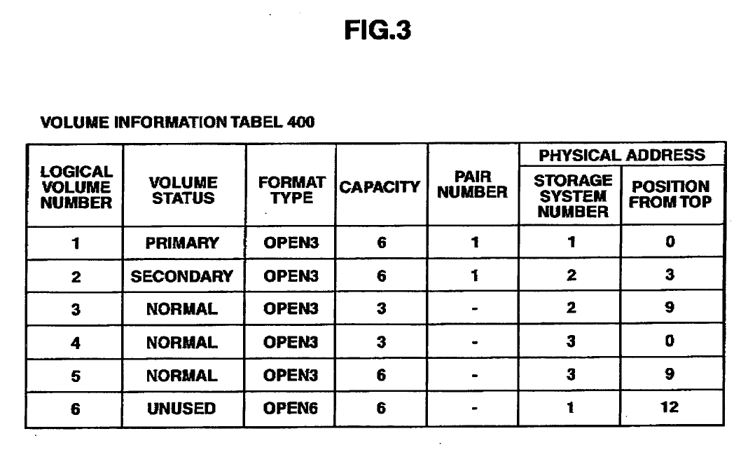

FIG. 3 indicates a format of a table defining logical volumes and their physical addresses on the HDD 100, as well as property information, such as a capacity and format type, and pair information regarding the logical volumes. A logical volume number is unique to each logical volume in a data center. In this table, “UNUSED” means that the logical volume is set but unused, and “PRIMARY” means that the volume is in the state that it can operate normally as a primary volume of a volume pair. “NORMAL” means that the volume is not set as a pair with another logical volume, but is in a normal state. “SECONDARY” means that the volume is set as a secondary volume of a pair, and is in the state that it can operate normally.

Logical volume number 1 represents the logical volume 110 (ORG1) of the first storage system 10, and forms a copy pair, referred to as pair number 1, with the logical volume 150 (Data 1) of the second storage system 15. Likewise, a logical volume 151 (JNL1) of the second storage system 15 is represented by logical volume number 3. A logical volume 201 of the third storage system 20 is represented by logical volume number 4, and a logical volume 200 of the third storage system 20 is represented by logical volume number 5.

The physical address in FIG. 3 means an address on an actual HDD. Based on this information, a microprocessor (not shown) in each disk adapter 80 shown in FIG. 2 controls the operation of writing data from the cache memory 60 to the actual HDD, and the operation of reading data from the HDD 100 to the cache memory 60.

The connecter 55 may be a switch for interconnecting the channel adapters and the cache memory, and others, or may also consist of buses. The shared memory (SM) 70 stores control information and a control table.

The operation of data update to the primary logical volume 110 (ORG1) of the storage system 10 at the first site being reflected in the logical volume 200 (Data 2) of the second storage system 20 at the third site via the storage system 15 at the second site is explained below. Copying of a data image of a source logical volume in which data is updated, to a destination logical volume is performed based on journal data. Journal data at the least consists of update data itself for an update of data in a source logical volume, update information indicating the location of the update in the source logical volume (e.g., logical address in the source logical volume), and a time stamp indicating the date and time of the update. When there is an update to data in the source logical volume, retaining the update journal data enables reproduction of the source logical volume from the journal data.

Assuming that there is a destination logical volume having the same data image as that of its source logical volume as of a certain point in time, if journal data is retained for every subsequent data update to the source logical volume, a data image of the source logical volume from that certain point in time can be reproduced to the destination logical volume using the journal data. Using journal data, a data image of the source logical volume can be produced in the destination logical volume without requiring the same capacity as that of the source logical volume. A volume retaining journal data corresponds to a journal logical volume.

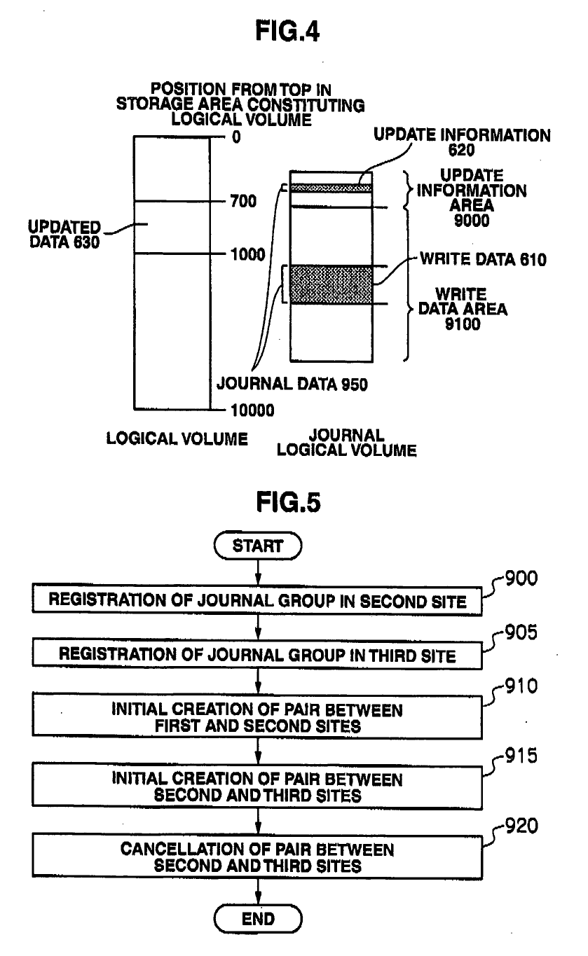

FIG. 4 indicates a state in which data at addresses 700 through 1000 in a source logical volume has been updated (updated data 630). A journal logical volume forming a pair with the logical volume stores the update data itself as write data 610 in a write data area 9100, and information concerning the update, such as address or time, as update information 620 in an update information area 9000. The write data 610 and the update information 620 collectively constitute journal data 950.

The journal logical volume is used upon being divided into the storage area 9000 storing the update information 620 (update information area), and the storage area 9100 storing the write data (write data area). The update information area 9000 stores update information from its top in the updated order (in the order of update numbers), and when the update information area 9000 reaches its limit, it stores update information from the top again. The write data area 9100 stores write data from its top, and when the write data area 9100 reaches its limit, it stores write data from the top again.

In FIG. 1, when the first storage system 10 receives a write command relating to data in the primary logical volume 110 (ORG1) of the first storage system 10 from the host computer 5 (step 250), data in the primary logical volume 110 (ORG1) of the first storage system is updated. The logical volume 150 (Data 1) in the second storage system 15 (at the intermediate site), which forms a pair with the updated primary logical volume (ORG1), is synchronously updated. Consequently, the second storage system 15 can immediately take over operation, even should any failure arise in the first storage system 10. This is because the second storage system 15 retains the secondary logical volume 150 (Data 1) having the same data image as that of the primary logical volume 110 (ORG 1) that the host computer 5 uses.

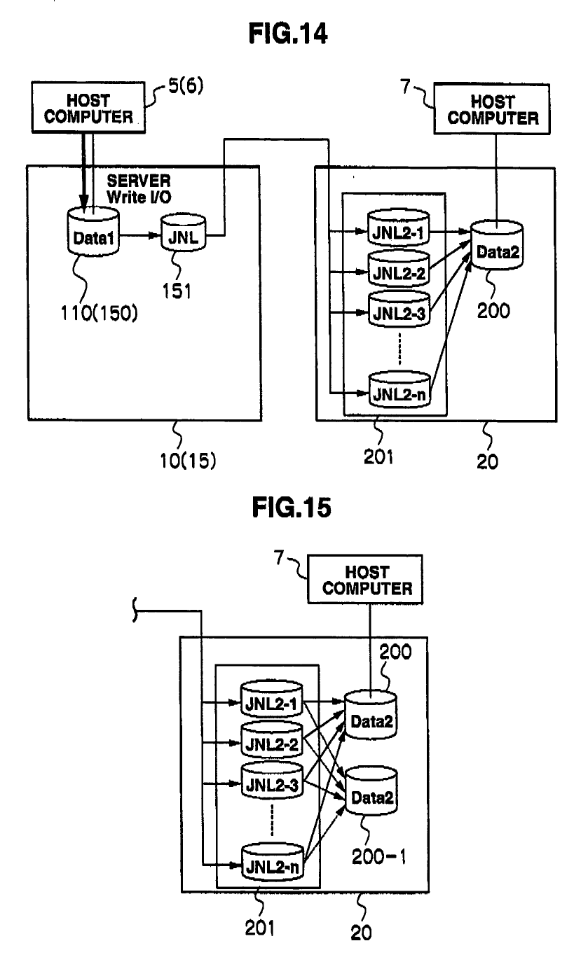

Meanwhile, the storage system 15 at the second site, when there is a data update to the logical volume 150 (Data 1), i.e., there is a data update to the logical volume 110 (ORG1) from the host computer 5, stores journal data in the journal volume 151 (JNL1) (step 260). The journal data stored in the journal volume 151 (JNL1) is asynchronously transferred (step 270) to the journal volume 201 (JNL2) in the remote third storage system 20 via the connection wire 240 (PUSH method). The journal volume 201, as shown in FIG. 14 explained later, consists of a plurality of journal volumes. The third storage system 20 reproduces the logical volume 200 (Data 2) corresponding to the logical volume 150 (Data 1) in the second storage system 15, using the journal data in the journal volume 201 (JNL2) (step 280). This operation corresponds to restore processing or recovery processing. Data in a journal volume in the second storage system 15 may also be read out to the third storage system 20, and stored in the logical volume 201 (JNL2) in the third storage system 20 (PULL method).

This PULL method is explained below in detail. The second storage system 15, upon receiving a journal read command for reading journal data out to the third storage system 20, reads journal data out of the journal logical volume 151 (JNL1), and sends it to the third storage system 20.

The third storage system 20 then reads the journal data from the journal logical volume 201 (JNL2) by restore processing 350, and updates data in the logical volume 200 (Data2). Thus, processing of reflecting a data update occurring in the primary logical volume 110 (ORG1) of the storage system 10 at the first site in the secondary logical volume 200 (Data2) of the storage system 20 at the third site becomes possible. In order to make it possible to recover a data image of the secondary logical volume as of a given recovery point, the journal volume 201, as described later, consists of a plurality of partial journal volumes.

The journal volume 151 (JNL1) in the second storage system 15 shown in FIG. 1, as explained above, is a storage area only for journal data, and makes it possible to reduce the storage area for replicated data, and also to replicate data from the first storage system 10 to the second and third storage systems 15 and 20 while suppressing consumption of storage area in the second storage system 15.

In order to build a data center system consisting of a plurality of sites as shown in FIG. 1, first, for example, a setting for making the logical volume 150 (Data 1) and the journal volume 151 (JNL1) form a journal group is required. A “journal group,” which refers to a pair of logical volumes, consists of a logical volume, and a journal volume that, upon a command to write data to the logical volume, stores the write command upon dividing it into update information, such as the address to which the data is to be written, and write data.

In the embodiment shown in FIG. 1, in the storage system 15, the logical volume 150 (Data 1) and the logical volume 151 (JNL1) form a journal group, and in the storage system 20, the logical volume 201 (JNL2) and the logical volume 200 (Data 2) form a journal group.

The flowchart shown in FIG. 5 illustrates an initial setting procedure for a journal group. A user sets a journal group in the respective storage systems using host computers 5, 6, and 7 (steps 900 and 905). In FIG. 1, journal groups in the storage system 15 at the second site, and in the storage system 20 at the third site, i.e., a pair of Data 1 and JNL1, and a pair of Data 2 and JNL2, are journal group 1 and journal group 2, respectively. As shown in FIG. 7, journal group setting information is retained in the shared memory (SM) 70 as a table 550.

Then, the user designates information indicating data to be replicated and information indicating where the data is to be replicated, and gives a pair registration command to the first and second storage systems 10 and 15, using a supervising client device or host computer connected to each storage system (step 910). Thus, a pair relationship is set between the logical volume 110 (ORG1) and the logical volume 150 (Data1) shown in FIG. 1.

Upon a pair being set, write processing performed on the primary logical volume becomes a trigger for conducting various processing for the secondary logical volume according to the status of the pair. The pair statuses are suspended status, paired status and initial copy status. When the pair status is ‘paired,’ processing for the data written in the primary logical volume to be also written in the secondary logical volume is performed; when the pair status is ‘suspended,’ the data written in the primary logical volume is not reflected in the secondary logical volume, and the difference between these volumes is retained in the first storage system 10 using a bit map. The journal group setting information and the above pair setting information is stored in the shared memory (SM) 70 shown in FIG. 2, and a microprocessor in each channel adapter 50 executes relevant processing based on the information.

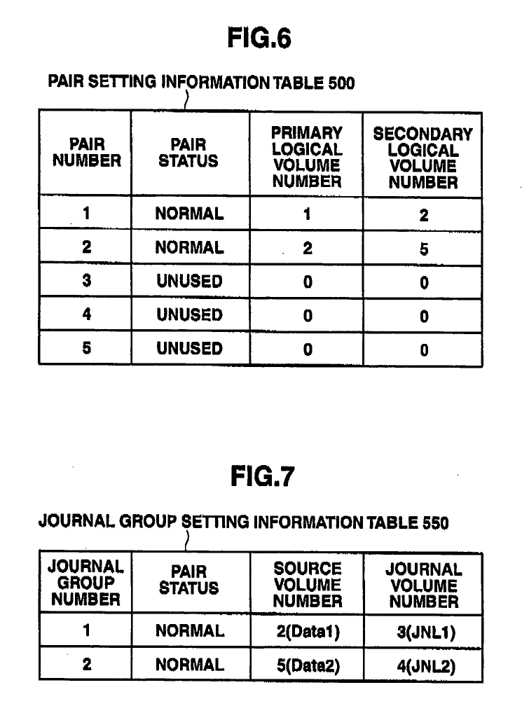

FIG. 6 shows an example of a pair setting information table 500 indicating pair statuses. The first row of the table in FIG. 6 indicates that a pair is formed between the logical volume 110 (ORG1) (logical volume number 1) of the first storage system 10 and the logical volume 150 (Data 1) (logical volume number 2) of the second storage system 15 as pair number 1. Furthermore, at step 910 shown in FIG. 5, an initial copy, which is initialization processing for making the data image of the logical volume 110 (ORG1) and that of the logical volume 150 (Data 1) identical to each other, is performed.

In the next step 915, a pair is formed designating the logical volume 150 (Data 1) and the logical volume 200 (Data 2), and an initial copy is performed, so that the logical volume 150 (Data 1) and the logical volume 200 (Data 2) have data images identical to each other as in the processing in the above step 910. The rows for pair number 2 in FIG. 6 indicate the status in which the above pair is set. The pair is cancelled after the initial copy is completed (step 920).

Upon the data image of the logical volume 110 (ORG1) of the first storage system being copied to the logical volume 150 (Data 1) in the storage system 15 and further to the logical volume 200 (Data 2) of the storage system 20, a manager in each of the storage systems 15 and 20 reports the completion of the initial copy to a service processor or the host computer 5. After the initial copy processing, it becomes possible to perform precise data restore processing (recovery) in the storage system 20.

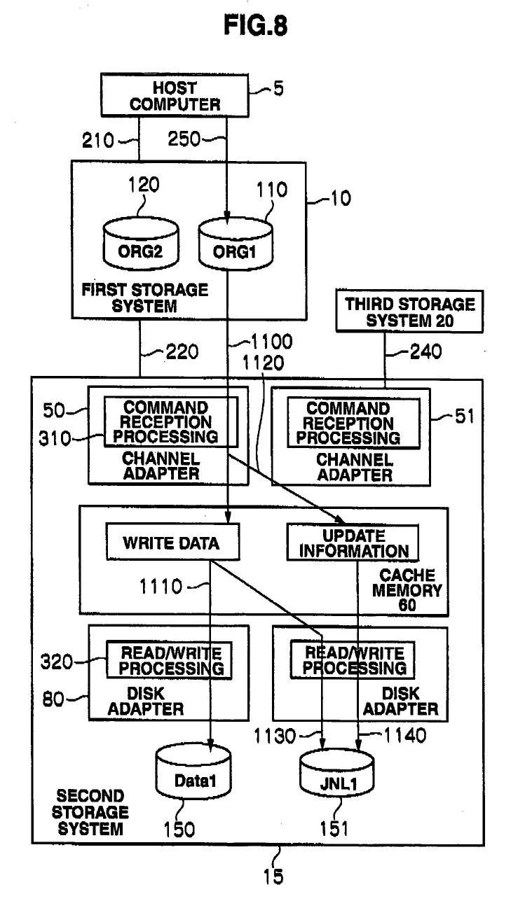

Next, the operation of a storage system is explained below in detail. FIG. 8 is a diagram illustrating data write processing performed by the storage system 15 at the second site. The second storage system 15 is connected to the storage system 10 at the first site with the connection wire 220 via the channel adapter 50. The first storage system 10 is connected to the host computer 5 via the connection wire 210.

The first storage system 10 receives data write commands from the host computer 5 via the connection wire 210 (step 250). When data is written in the logical volume 110 (ORG1), the second storage system 15 receives a data write command from the first storage system 10 via the connection wire 220. An arrow 1100 indicates the flow of data in the second storage system 15 when a data write command is received for the logical volume 150 (Data 1), to which data is to be replicated. The channel adapter 50, upon receiving a command from the first storage system 10 to write data to the logical volume 150 (Data 1), makes the cache memory 60 retain the write data and update information. The write data retained in the cache memory 60 is written in the logical volume 150 (Data 1) by the disk adapter 80 at a different time to that when the data is written in the cache memory (step 1110).

The update information written in the cache memory 60 is written in the update information area of the logical volume 151 (JNL1), and also, the write data is written in the write data area of the logical volume 151 (JNL1) (step 1120). The disk adapter 80 writes the write data and update information in the cache memory 60 to an address assigned to the logical volume 151 (JNL 1) in the HDD (steps 1130 and 1140). Meanwhile, the channel adapter 51 connected to the third storage system 20 via the connection wire 240 receives from the third storage system 20 a command to read out the logical volume 151 (JNL 1).

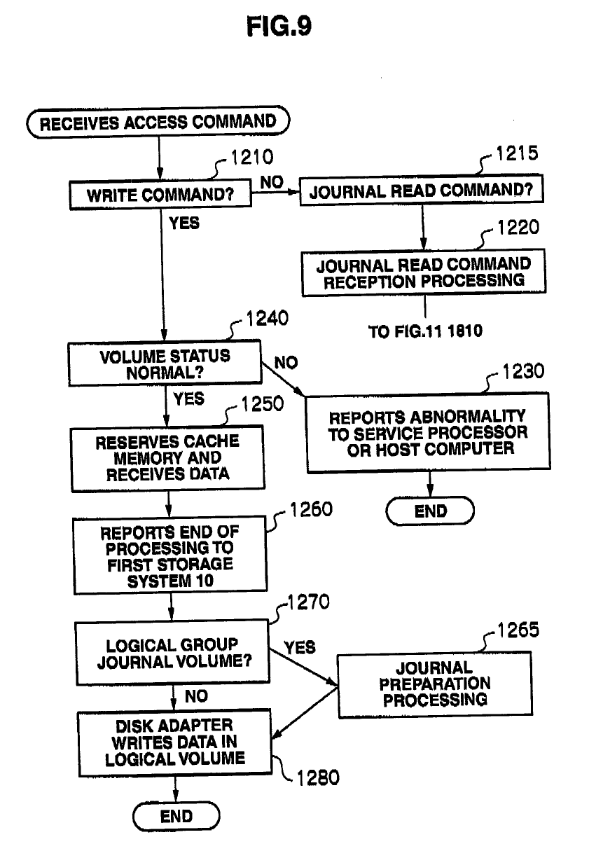

FIG. 9 is a flowchart indicating processing for when the logical volume 150 (Data 1) of the storage system 15 at the second site receives a command from the storage system at the first site. The microprocessor included in the channel adapter 50 shown in FIG. 8, upon receiving an access command from the first storage system 10, checks the kind of command (step 1210). The channel adapter may receive a write command, as the channel adapter shown in FIG. 8 does, or may also receive a read command from another storage system, as the channel adapter 51 does.

If the received access command is not a write command, but is a journal read command from the third storage system 20, journal read command reception processing is performed (steps 1215 and 1220). At step 1210, if the access command is a write command, the volume status of the logical volume 150 (Data 1) is checked (step 1240). As shown in FIG. 3, the status of each logical volume is stored in table format in the shared memory (SM) 70 as volume information. At step 1240, if the volume status of the logical volume 150 (Data 1) is not normal, it is impossible to access the logical volume 150 (Data 1), so an abnormality is reported to the host computer 5 and then the processing ends (Step 1230).

At step 1240, if the volume status of the logical volume 150 (Data 1) is normal, the channel adapter 50 receives data from the cache memory 60 (step 1250). The channel adapter 50 reports the completion of the preparation for receiving data to the first storage system 10, and then the first storage system 10 sends write data to the second storage system 15. The channel adapter 50 of the second storage system 15 receives the write data, and stores the same in a reserved storage area of the cache memory 60 (see step 1250; and 1100 in FIG. 8). Subsequently, at step 1260, the end of the processing is reported to the first storage system 10. Next, the channel adapter 50 checks whether the logical volume 150 (Data 1) is a journal group logical volume, with reference to the journal group setting information table 550 (FIG. 7) written in the shared memory (SM) 70 (step 1270). FIG. 7 indicates which logical volumes form the respective journal pairs. The first row in the table indicates that logical volume numbers 2 and 3 form a journal group. The logical volume 150 (Data 1) and the logical volume 151 (JNL1) of the second storage system 15 form a journal pair.

If the logical volume 150 (Data 1) is a journal group logical volume, journal preparation processing is performed on the journal logical volume 151 (JNL1) that forms a journal group together with that volume (step 1265). Subsequently, the disk adapter 80 writes data to the logical volume 150 (Data 1) and logical volume 151 (JNL 1) defined in the HDD (step 1280; and 1130 and 1140 in FIG. 8)

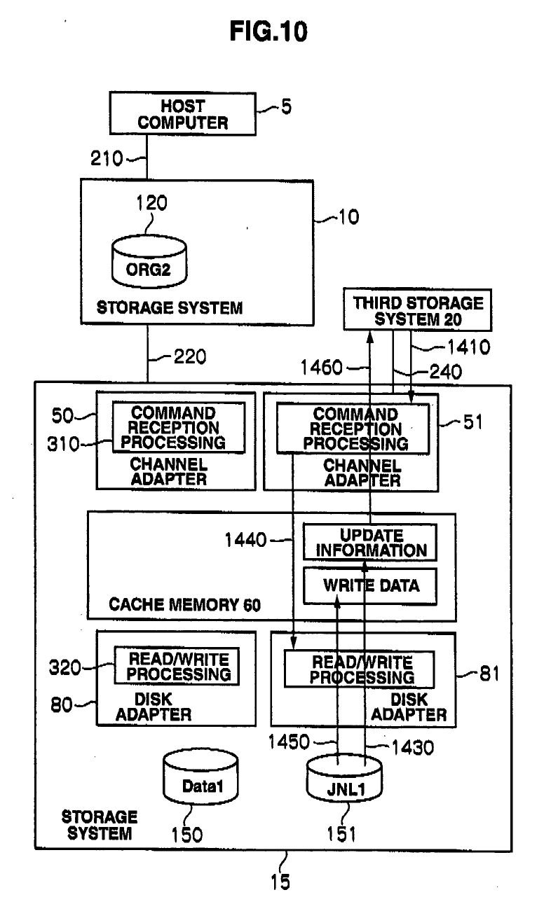

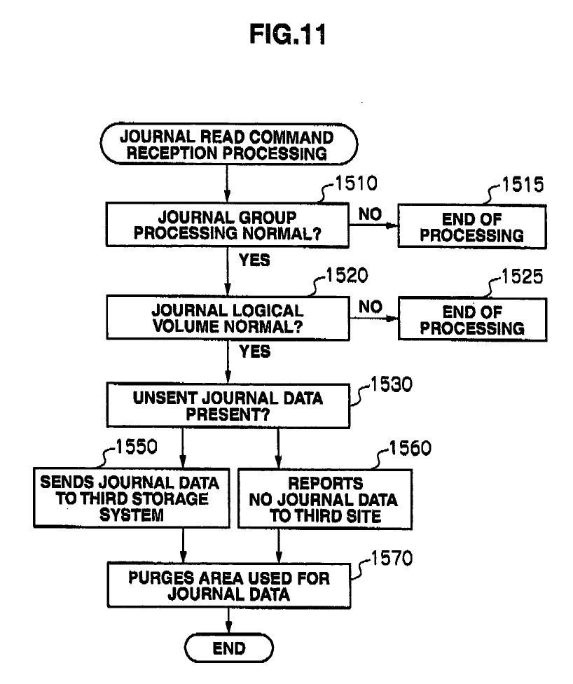

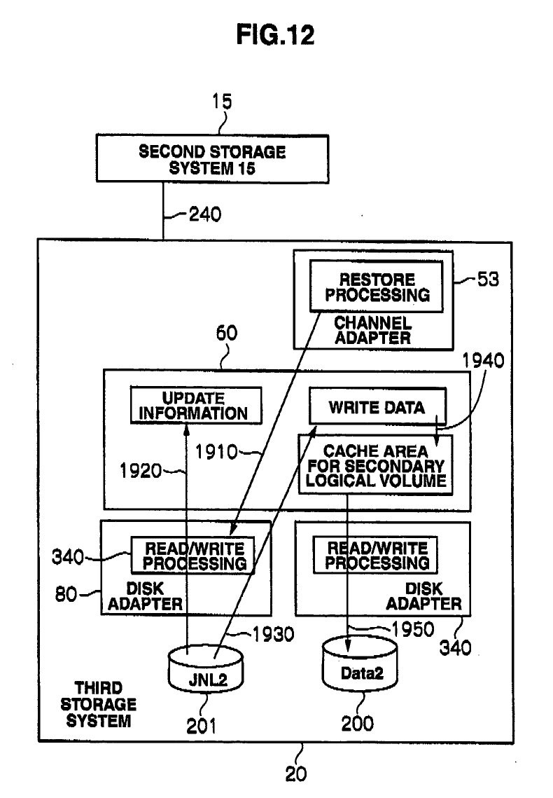

As described above, the journal is prepared in the second storage system 15, and the journal data of the journal is sequentially stored in the journal volume 151 (JNL 1), Triggered by a certain factor, the journal data is asynchronously sent to the journal volume 201 (JNL 2) of the third storage system 20. Examples of this are the PUSH method and the PULL method. The PULL method is explained below based on FIG. 10. FIG. 10 illustrates the operation of the channel adapter 51 of the second storage system 15 when the channel adapter 51 has received a journal read command (journal read command reception processing). FIG. 11 indicates a flowchart of that operation. FIG. 12 illustrates the operation of the second storage system 15 when it has received a journal read command from the third storage system 20.

The channel adapter 51 in the second storage system 15 receives an access command from the third storage system 20 (step 1410 in FIG. 10), and if the access command is a journal read command, it checks whether or not the journal group status is “normal”, with reference the table shown in FIG. 7 (step 1510). As step 15101 if the journal group status is anything other than “normal,” e.g., “failure,” the channel adapter 51 notifies the third storage system 20 of that journal group status, and then ends the processing. The third storage system 20 performs processing according to the notified journal group status. For example, if the journal group status is “failure,” the third storage system 20 ends the journal read processing (step 1515).

At step 1510, if the journal group status is “normal,” the channel adapter 51 examines the status of the journal logical volume (step 1520). At step 1520, if the volume status of the journal logical volume is not “normal,” e.g., when the status is “failure,” the channel adapter 51 changes the journal group status shown in FIG. 7 to “failure,” notifies the storage system 20 of the journal group status, and then ends the processing (step 1525).

At step 1530, the channel adapter 51 checks whether or not unsent journal data is present, and if it is, it sends that unsent journal data to the third storage system 20 (step 1550). If all of the journal data has already been sent to the third storage system 20, the channel adapter 51 reports “no journal data” to the third storage system 20 (step 1560). Subsequently, it purges the area where the journal data is present (step 1570). If any unsent journal data is present, the channel adapter 51 gives the disk adapter 80 a command to write that update information and write data to the cache memory 60 (1410 in FIG. 10).

The disk adapter 81 performs read/write processing by reading the update information and write data out of the logical volume 151 (JNL 1), which constitutes one of the logical areas formed separately on the HDD 100, storing the same in the cache memory 60 and then notifying the end of the processing to the channel adapter 51 (1430 and 1450 in FIG. 10). The channel adapter 51, upon being notified of the end of the processing for reading write data and update information out to the cache memory 60, sends the update information and write data to the third storage system 20 from the cache memory 60, and then purges the area of the cache memory 60 that retains the journal data (1460 in FIG. 10). The channel adapter 51 purges the storage area for the journal data sent to the third storage system 20 during the processing of the previous journal read command (step 1570).

The third storage system 20, upon receiving the journal data, stores the received journal data in the journal volume 201 (JNL 2) Subsequently, the third storage system 20 performs journal restore processing. The third storage system 20 executes a journal restore program to restore data in the logical volume 200 (Data 2) based on the journal volume 201 (JNL 2). The area storing the journal data, the restore processing of which has been completed, is purged, and is used to store new journal data.

FIG. 14 is a block diagram illustrating a detailed configuration of the journal volume 201 (JNL 2). As shown in FIG. 14, the journal volume 201 (JNL 2) of the third storage system 20 consists of a collection of a plurality of journal volumes. This group of journal volumes consists of a plurality of journal volumes JNL2-1 to JNL2-n so as to correspond to a plurality of journal data generated at given time intervals from a designated point in time. For example, eight journal volumes can be provided in order to store journal data for each date from Monday to the following Monday. A journal volume storing update data for Monday is made to be JNL2-1, that for Tuesday is made to be JNL2-2, that for Wednesday is made to be JNL2-3, that for Thursday is made to be JNL2-4, that for Friday is made to be JNL2-5, that for Saturday is made to be JNL2-6, that for Sunday is made to be JNL2-7, and that for the following Monday is made to be JNL2-8. The information necessary for setting that these journal volumes constitute a group 201 is set in the shared memory (SM) 70 of the second storage system 20 in the form of a control table. This setting is performed by the host computer 7 or a supervising terminal.

The channel adapter or disk adapter of the third storage system 20 allocates journal data sent from the journal volume 151 (JNL1) of the second storage system 15 to any of the journal volumes JNL2-1 to JNL2-n with reference to data in the time stamp in the journal data, and then stores the same therein. For example, update data (journal data) added to the volume 110 by the host computer 5 on Monday following a certain point in time may be stored in the journal volume JNL2-1, and that for Tuesday may be stored in the journal volume JNL2-2. The journal data for Monday to Sunday is reflected in the logical volume 200 (Data 2) at a predetermined time the following Monday (e.g., 0:00 p.m.). Subsequently, the third storage system 20 purges the stored contents of the respective journal volumes JNL2-1 to JNL2-7, and then sequentially allocates journal data sent from the second storage system 15 to the respective journal volumes JNL2-1 to JNL2-7 and stores the same therein. Incidentally, the system shown in FIG. 14 has a configuration in which the first storage system 10 and the second storage system 15 are integrated.

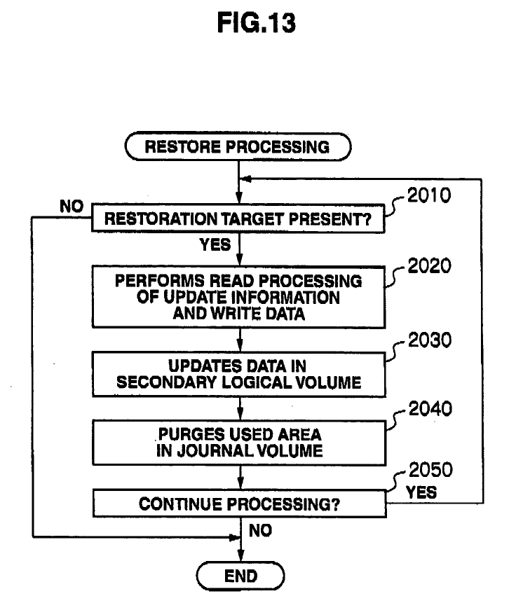

An operation for a channel adapter 53 of the third storage system 20 to update (recover) data using journal data is explained below with reference to FIGS. 12 and 13. Recovery processing may also be performed by the disk adapter 80 of the storage system 20. At step 2010 in FIG. 13, a host computer selects a target journal volume for recovery, and examines whether or not any target journal data for recovery is present in the selected journal volume. The channel adapter 53, if no target journal data is present, halts the recovery processing, and prepares for new recovery processing (step 2010).

At step 2010, if target journal date for recovery is present, the following processing is performed on the oldest journal data. Update numbers are assigned in series to the journal data, and restore processing is started from update information of the journal data having the oldest (smallest) update number. The channel adapter 53 reserves an area of the cache memory 60 (1910 in FIG. 12), and the disk adapter 80 reads update information and write data from the cache memory 60 starting from the journal data having the oldest update information (step 2020; and 1920 and 1930 in FIG. 12). Specifically, a disk adapter 83 of the third storage system 20 performs read/write processing 340, thereby reading update information from the HDD 100 storing the update information therein and storing the same in the cache memory 60, and then it notifies the channel adapter 53 of the end of the processing.

Likewise, the disk adapter 83 of the third storage system 20 obtains write data on the basis of the read update information (step 1930), and gives a command to read the write data out to the area of the cache memory 60 corresponding to the address of the data to be updated in the logical volume 200 (Data 2) (step 2020; and 1940 in FIG. 12).

The disk adapter 83 then writes the write data from the cache area for the secondary logical volume to the secondary logical volume 200 (Data 2) (1950 in FIG. 12; and step 2030). Then, it purges the area of the logical volume 201 (JNL2) where the update information and write data that have been reflected in the secondary logical volume 200 (Data 2) are present (step 2040). Subsequently, whether or not recovery has been completed with regard to the selected journal volume is judged, and if recovery has been completed with regard to all of the journal volumes, the routine shown in FIG. 13 ends (step 2050).

For example, if recovery of the data volume 200 is performed according to journal data up to Wednesday, the journal volumes JNL2-1 through JNL2-3 shown in FIG. 14 are selected at step 2010 shown in FIG. 12. The data volume as of any point in time selected by the user can be recovered by reflecting all of the journal data in the selected journal volumes in the data volume 200. For example, if it were Saturday now, it would be possible to recover data as of Wednesday.

FIG. 15 is a modified example of the configuration shown in FIG. 14. In FIG. 15, the third storage system 20 is provided with a plurality of data volumes 200 and 200-1. These data volumes are capable of accessing their respective journal volumes, Furthermore, the channel adapter or disk adapter (controller) of the third storage system 20 can arbitrarily select a journal volume that each data volume accesses. Otherwise, it also can allow only a specific journal volume to be inaccessible. For example, the data volume 200 may be recovered based on the journal data in the journal volume JNL2-1, and the data volume 200-1 may also be recovered based on the journal data in the journal volume JNL2-2. The above configuration enables a plurality of data volumes recovered as of a given point in time to be placed at a remote site.

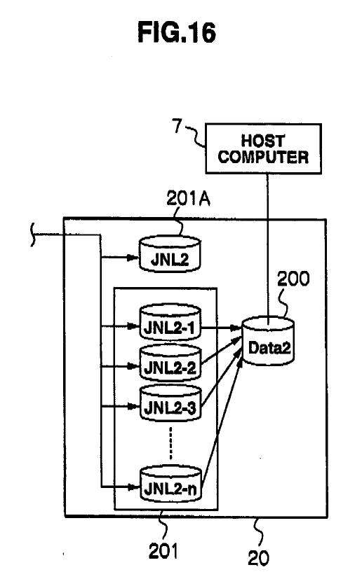

FIG. 16 is a modified example of a journal volume of the third storage system 20. In this configuration, the third storage system 20 is provided with a journal volume JNL2 (201A) in which all journal data added to the storage system at the local site from the host computer 5(6) is stored. This journal volume is paired with another logical volume (not shown), and all journal data can be reflected in that other volume.

According to the above-described embodiment, it is possible to arbitrarily set a recovery point for a storage system in a data center at a remote site, irrespective of its OS file system, and without requiring various complicated operations on the application program side, thereby enabling retention of the status of a data-stored volume as of a given point in time.

Furthermore, as shown in FIG. 14, the plurality of journal volumes JNL2-1 to JNL2-n generated at given time intervals from a designated point in time is retained at the remote site, and the data-stored volume 200 (Data 2) to which only journal data before the designated point in time has been applied is retained, thereby enabling generation management of back-ups in a data center storage system at a remote site. This will lead to reduction in the required number of back-up volumes and their capacity, which has conventionally been a problem.

The above-described embodiment defines that a journal volume at a remote site stores journal data for each day of a week. However, it is also possible to define that a journal volume stores journal data at arbitrary time intervals, such as a day, month, or year.

Moreover, a plurality of logical volumes (LU) may be provided at the remote site, and the controller may select a specific logical volume and recover the specific logical volume on the basis of journal data in a specific journal volume.

What is claimed is:

1. A remote copy system including a local site having a first storage system connected to an information processing unit, for transmitting and receiving data to and from the information processing unit, and a remote site having a second storage system connected to the first storage system, for receiving data from the first storage system,
the first storage system comprising a first storage area having a first logical volume in which data transmitted from the information processing unit is written, and a first controller for controlling data exchange between the first storage area and the information processing unit; and
the second storage system comprising a second storage area having a second logical volume forming a remote copy pair with the first logical volume, and a plurality of journal volumes storing journal data relating to the first storage area, and a second controller for controlling data exchange between the first storage area and the second storage area.

2. The remote copy system according to claim 1, wherein the plurality of journal volumes respectively store the journal data generated at predetermined time intervals from a designated point in time.

3. The remote copy system according to claim 1, wherein the second controller recovers data in the second storage area on the basis of data stored in a specific journal volume, pursuant to a user's instruction to select the specific volume from the plurality of journal volumes.

4. The remote copy system according to claim 2, wherein each of the plurality of journal volumes is set for a day, a week or a month corresponding to the predetermined time intervals.

5. A remote copy system including a storage system connected to an information processing unit, for transmitting and receiving data to and from the information processing unit, comprising:
a storage area; and
a controller for controlling data transmission and reception between the storage area and the information processing unit,
wherein the storage area comprises a copy source volume, a copy destination volume, and a plurality of journal volumes in which update data transmitted from the information processing unit to the copy source volume is separately stored; and
wherein the controller reproduces a data image of the copy source volume in the copy destination volume on the basis of the plurality of journal volumes.

6. The remote copy system according to claim 5, wherein the controller reproduces the data image of the copy source volume in the copy destination volume on the basis of data stored in a specific journal volume, pursuant to a user's instruction to select the specific volume from the plurality of journal volumes,

7. The remote copy system according to claim 1, wherein the second logical volume consists of a plurality of logical volumes, and the second controller arbitrarily selects a journal volume used for recovery of each logical volume from the plurality of journal volumes, pursuant to a user's instruction.
